(19) United States
(12) Patent Application Publication
(10) Pub. No.: US 2014/0292014 A1
(43) Pub. Date: Oct. 2, 2014

(54) MOUNTING SYSTEM FOR CAB

(71) Applicant: Caterpillar SARL, Geneva (CH)

(72) Inventor: Scott A. Christianson, Edelstein, IL (US)

(21) Appl. No.: 14/307,655

(22) Filed: Jun. 18, 2014

(51) Int. Cl. B62D 33/06

(52) U.S. Cl. CPC B62D 33/0604
USPC 296/35.3

(57) ABSTRACT

A cab frame mounting system is disclosed. The cab frame mounting system includes a cab mount to mount to a cab and a frame mount to mount to a frame. The cab frame mounting system includes a pin configured to couple the cab mount and the frame mount. The pin defines a pin axis. Further, the cab mount includes a bracket. The bracket has an upright member having an opening formed therein to receive the pin. The frame mount includes a mounting head. The mounting head includes a base structure. The cab mount also includes a protruding head having an opening formed therein to receive the pin. The bracket of the cab mount includes a flange portion extending from the upright member. The bracket is coupled to the base structure of the mounting head with removable mechanical fasteners.

### TECHNICAL FIELD

The present disclosure relates to a mounting system, and more particularly, to the mounting system for mounting a cab on a machine.

### BACKGROUND

Construction machines, for example, trucks, include an operator cabs. The cab for each machine may have an operator interface therein to allow an operator seated within the cab to maneuver the machine and/or perform an operation using a work implement of the machine.

During maintenance, the cab may need to be removed or tilted in order to access components present below the cab. Accordingly, in some machines, the cabs are pivotally mounted to a frame of the machine, via a mount structure. However, the design of the mount structure is such that during machine operation, the cab may experience fore and aft movements about the pivot connection to the frame of the machine. This may affect an overall experience of the operator, impacting the operator ride and perception. Hence, there is a need to provide an improved mount structure for the cab.

U.S. Pat. No. 8,657,251 describes a cab frame supported on brackets provided at a plurality of positions of a vehicle body frame with dampers. Movement limiting mechanisms for limiting a movement at least in a vertical direction of the cab frame are provided between the brackets and the cab frame. Further, the movement limiting mechanisms are provided at least at two positions. Each movement limiting mechanism includes a lower limiting portion arranged close to the brackets and constituted by a plate member, and an upper limiting portion arranged close to the cab frame and constituted by a plate member in the same manner.

### SUMMARY OF THE DISCLOSURE

In one aspect of the present disclosure, a cab frame mounting system is disclosed. The cab frame mounting system includes a cab mount to mount to a cab. The cab frame mounting system also includes a frame mount to mount to a frame. The cab frame mounting system further includes a pin. The pin is configured to couple the cab mount and the frame mount. The pin defines a pin axis. Further, the cab mount includes a bracket extending from the cab. The bracket has an upright member having an opening formed therein to receive the pin. The frame mount includes a mounting head. The mounting head includes a base structure. The cab mount also includes a protruding head member extending from the base structure. The protruding head member includes an opening formed therein to receive the pin. The frame mount also includes an abutment portion to attach to the frame. The frame mount further includes an isolation member disposed between the base structure and the abutment portion. The bracket of the cab mount includes a flange portion extending from the upright member along the same direction as the base structure. The bracket is coupled to the base structure of the mounting head with removable mechanical fasteners extending in a direction obliquely to the pin axis.

In another aspect of the present disclosure, a cab frame mounting system is disclosed. The cab frame mounting system includes a cab mount to mount to a cab. The cab frame mounting system also includes a frame mount to mount to a frame. The cab frame mounting system further includes a pin to couple the cab mount and the frame mount. The pin defines a pin axis extending in a lateral direction. The cab mount includes a bracket extending from the cab. The bracket has an upright member having an opening formed therein to receive the pin. Further, the frame mount includes a mounting head. The mounting head includes a base structure. The mounting head also includes a protruding head member extending from the base structure. The protruding head member includes an opening formed therein to receive the pin. The protruding head member also includes an abutment portion to attach to the frame. The protruding head member further includes an isolation member disposed between the base structure and the abutment portion. The bracket of the cab mount includes a flange portion extending from the upright member along the same direction as the base structure. The bracket is coupled to the base structure of the mounting head with removable mechanical fasteners extending in a downward direction away from the pin axis.

Other features and aspects of this disclosure will be apparent from the following description and the accompanying drawings.

### BRIEF DESCRIPTION OF THE DRAWINGS

FIG. 1 is a perspective view of an exemplary machine, according to one embodiment of the present disclosure;

FIG. 2 is perspective view of a cab of the machine of FIG. 1, and a mounting system for the cab, according to one embodiment of the present disclosure; and

FIG. 3 is a perspective cross sectional view of the mounting system for the cab.

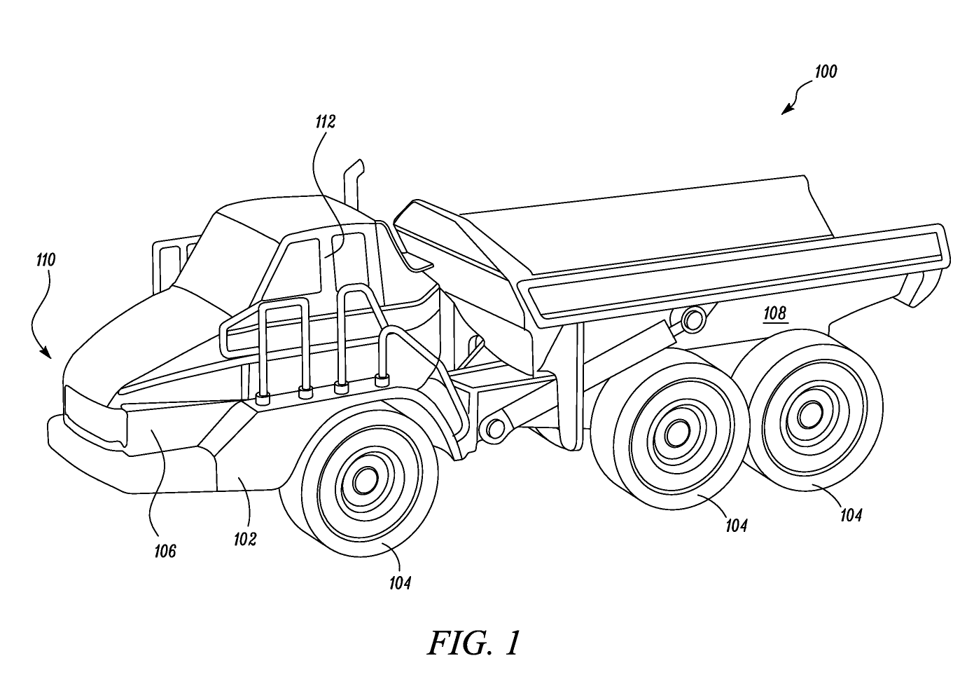

### DETAILED DESCRIPTION

Wherever possible, the same reference numbers will be used throughout the drawings to refer to the same or the like parts. FIG. 1 illustrates an exemplary machine 100. In one embodiment, the machine 100 may embody an articulated truck. Alternatively, the machine 100 may include a track-type tractor, a hydraulic excavator, a wheel loader, a haul truck, a large mining truck, an off-highway truck, and the like. It should be understood that the machine 100 may embody any wheeled or tracked machine associated with mining, agriculture, forestry, construction, and other industrial applications.

As illustrated in FIG. 1, the machine 100 may be a wheeled machine including a frame 102, wheels 104, an engine compartment 106, and a payload carrier 108. The machine 100 may further include an engine positioned in the engine compartment 106 and supported on the frame 102. The engine may be an internal combustion engine such as, for example, a reciprocating piston engine or a gas turbine engine. According to one embodiment of the present disclosure, the engine is a spark ignition engine or a compression ignition engine such as, a diesel engine, a homogeneous charge compression ignition engine, or a reactivity controlled compression ignition engine, or other compression ignition engine known in the art. The engine may be fueled by gasoline, diesel, biodiesel, dimethyl ether, alcohol, natural gas, propane, hydrogen, combinations thereof, or any other combustion fuel known in the art.

In an exemplary embodiment, a cab 112 is mounted on a front end 110 of the frame 102 of the machine 100. The cab 112 is disposed above the engine and extends rearward beyond the engine. It may be contemplated that the cab 112 may enclose the engine by forming a portion of the engine compartment 106. The cab 112 may include a suitable station for a machine operator, and may house various controls, displays, and interface equipment for machine operation. In addition, the cab 112 may be structured in such a way as to provide roll-over protection to the machine operator, and also to mitigate potential damage to the machine 100 in the event of roll-over.

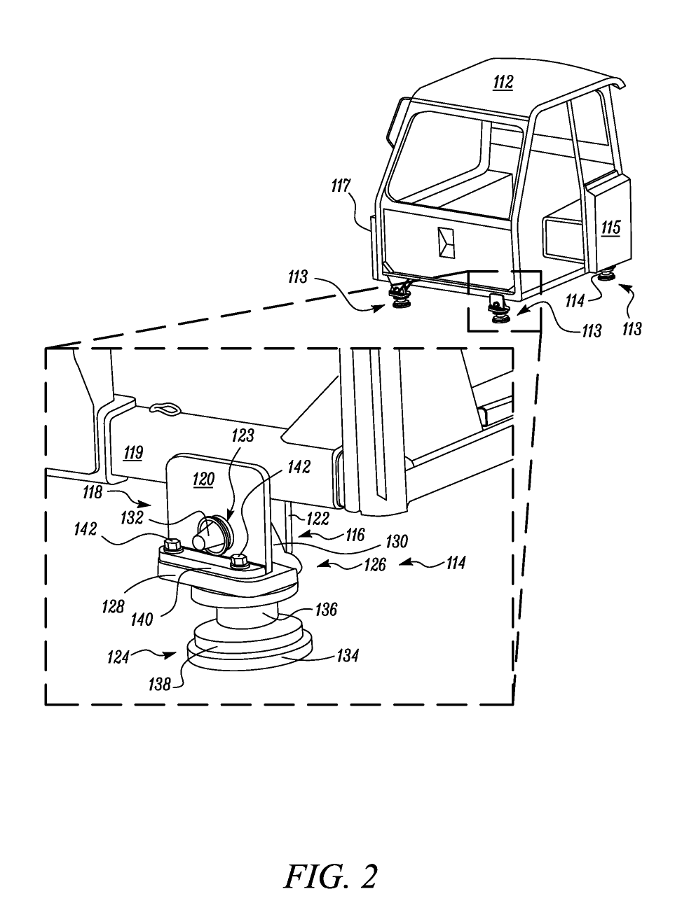

FIG. 2 is a perspective view of the cab 112, according to an embodiment of the present disclosure. The cab 112 may be pivotally mounted to the frame 102, such that the cab 112 may tilt in order to access the engine for maintenance. The cab 112 may tilt forward, rearward and/or sideward with respect to the frame 102 of the machine 100.

A number of mounting structures 113 may be provided in association with the cab 112 and the frame 102, in order to allow the cab 112 to tilt with respect to the frame 102 of the machine 100. For example, as illustrated in FIG. 2, four mounting structures 113 may be provided at four different corners of the cab 112. Three out of these four mounting structures 113 are visible in FIG. 2. The design and construction of the mounting structures 113 may vary based on the application. In one embodiment, a mounting system 114 present on one side 115 of the cab 112, may be different in construction and functionality from that present on an opposite side 117 of the cab 112.

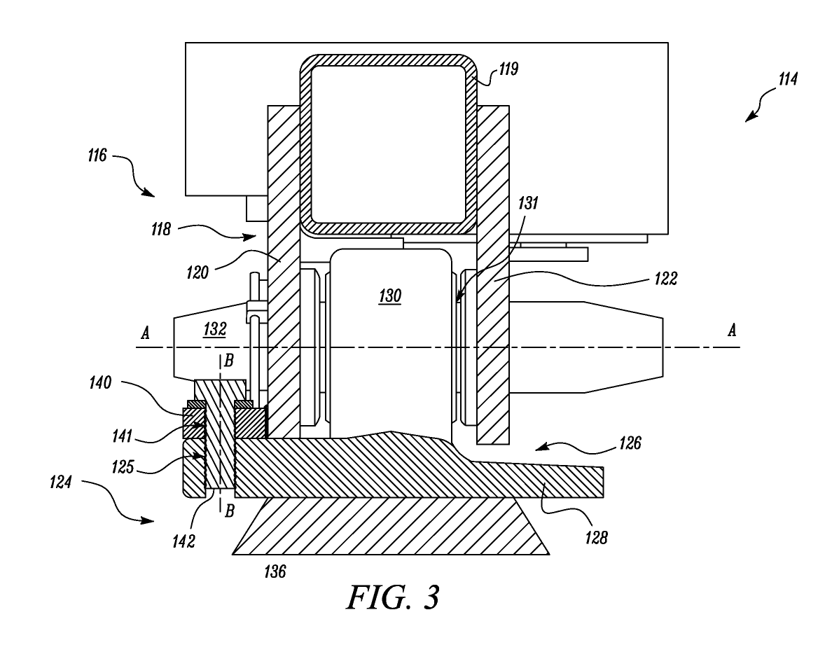

Referring to FIGS. 2 and 3, the mounting system 114 includes a cab mount 116. The cab mount 116 is configured to be attached to a bottom of the cab 112 of the machine 100. The cab mount 116 can include a bracket 118. The bracket 118 is positioned to extend downwardly from a bottom of a cab frame 119. In one example, the bracket 118 can include a pair of upright members, namely a first upright member 120 and a second upright member 122. The first and second upright members 120, 122 may have a square or a rectangular shape. Each of the first and second upright members 120, 122 include an opening 123 provided therein extending in a lateral direction. The openings 123 of the first and second upright members 120, 122 are co-axial.

The mounting system 114 also includes a frame mount 124. The frame mount 124 is attached to the frame 102 of the machine 100. The frame mount 124 includes a mounting head 126. Further, the mounting head 126 includes a base structure 128 and a protruding head member 130. The protruding head member 130 extends in an upright direction, and in one example, vertically upwards, from an upper surface of the base structure 128. In one example, the protruding head member 130 may have a semi-circular design.

The protruding head member 130 can include an opening 131 provided therein. The openings 123, 131 provided within the upright members 120, 122 and the protruding head member 130 can be aligned such that a pin 132 may be received therewithin. The pin 132 defines a pin axis A-A extending generally in a lateral direction, and is configured to couple the cab mount 116 and the frame mount 124. The first and second upright members 120, 122 of the cab mount 116 are configured to pivot in unison, thereby tilting the cab 112 during servicing or maintenance operations.

A shaft (not shown) can be coupled to a lower surface of the base structure 128 in a manner to extend downwardly from the lower surface. The shaft may be embodied as a cylindrical rod provided with a bore therein. One end of the shaft is attachable to the lower surface of the base structure 128, whereas another end is attachable to the frame 102 of the machine 100.

As shown in FIG. 2, the frame mount 124 can include an abutment portion 134. The abutment portion 134 can be positioned to surround the shaft. The abutment portion 134 may embody a disc. Further, an isolation member 136 can be disposed between the base structure 128 and the abutment portion 134, such that the isolation member 136 is positioned to surround the shaft. The isolation member 136 is configured to damp noise and vibrations travelling between the frame 102 and the cab 112. In one example, the isolation member 136 may be made of, e.g., rubber, or other elastomer materials. Further, a washer 138 may be provided between the isolation member 136 and the abutment portion 134, and surrounding the shaft. The washer 138 may be made of a metallic material such as, e.g., steel.

As discussed earlier, the cab 112 may tilt about the pin 132 in order to access the engine or other components of the machine 100 that are provided below the cab 112. However, it is not desirable for the cab 112 to pivot or tilt during the machine operation. The tilting of the cab 112 during operation may create an uncomfortable environment for the machine operator. The present disclosure relates to the provision of the mounting system 114 that may lock the cab 112 with respect to the frame 102, thereby further inhibiting the movement of the cab 112 during operation of the machine 100 after the servicing and maintenance operations.

Referring to FIG. 3, the bracket 118 of the cab 112 mount includes a flange portion 140. In the illustrated embodiment, the flange portion 140 extends from the first upright member 120 along the same direction as the base structure 128. More particularly, the flange portion 140 extends outwards from the first upright member 120, parallel to the pin axis A-A. The flange portion 140 may be attached to the first upright member 120 using joining methods such as, welding or brazing. Alternatively, mechanical fasteners may be used to attach the flange portion 140 with the first upright member 120. In an alternate embodiment, the flange portion 140 may form an integral part of the first upright member 120.

Further, the flange portion 140 may include a plurality of openings 141, one such opening 141 is as shown in FIG. 3. The base structure 128 of the frame mount 124 also includes a corresponding number of openings 125, one such opening 125 is as shown in FIG. 3. The openings 141, 125 of the flange portion 140 and the base structure 128 respectively are coaxially aligned, such that a mechanical fastener 142 may pass therethrough, generally in a downward direction. The mechanical fasteners 142 define an element axis B-B. The axis B-B of the mechanical fasteners 142 extends in a direction oblique to the pin axis A-A, and can be in one example, perpendicular to one another. The mechanical fasteners 142 may include any of a bolt, screw, rivet, pin, and the like.

During machine operation, the mechanical fasteners 142 are coupled to the flange portion 140 and the base structure 128, thereby inhibiting or reducing fore/aft movements of the cab 112 about the pin 132. For servicing or maintenance purposes, the mechanical fasteners 142 may be removed, so that the cab 112 may tilt about the pin 132, in order to access various components of the machine 100 present underneath the cab 112.

It should also be noted that the cab mount 116 and the frame mount 124, may be decoupled when the pin 132 and the mechanical fastener 142 are removed. The mounting system 114 is provided on the one side 115 of the cab 112 that can be accessed by the maintenance and service personnel, such that on the removal of the pins 132 and the mechanical fasteners 142 the cab mount 116 and the frame mount 124 of the mounting system 114 is decoupled. The decoupling allows the cab 112 to tilt along the mounting structures 113 present on the opposite side 117 of the cab 112. In one example, the mounting structures 113 present on the opposite side 117 of the cab 112 may not include the mechanical fastener design and functionality. On the one side 115 of the cab 112, the decoupling of the cab mount 116 and the frame mount 124 allows for the cab 112 to be tilted away from the frame mount 124, thereby providing a better access to the components of the machine 100 present underneath the cab 112. After the servicing and maintenance operations, the cab 112 may be restored to a non-tilt position, and the pin 132 and the mechanical fastener 142 can be attached.

### INDUSTRIAL APPLICABILITY

Machines, for example, an articulated truck include the operator cabs. In a situation wherein the engine of the machine is mounted below the cab, the cab may need to be tilted during maintenance, so that maintenance personnel can access components present below the cab.

The mounting system 114 of the present disclosure includes the first upright member 120. Further, the mounting system 114 includes the flange portion 140 extending from the first upright member 120. The flange portion 140 is releasably coupled to the base structure 128 using the mechanical fasteners 142. During machine operation, the mechanical fasteners 142 are engaged with the mounting system 114, such that the flange portion 140 locks the cab 112 mount with respect to the frame mount 124, thereby restricting, minimizing or eliminating the movement of the cab 112 about the pin 132. Further, the mechanical fasteners 142 may be disengaged from the base structure 128, so that the cab 112 may tilt about the frame 102 of the machine 100 during servicing or maintenance operations.

The mounting system 114 described herein provides improved machine operating conditions, including, but not limited to, an improved ride and operator perception may be achieved. The mounting system 114 allows for flexibility in tilting of the cab 112 when the mechanical fasteners 142 are disengaged, and also allows for the cab 112 to be locked with respect to the frame 102 when the mechanical fasteners 142 are removed.

The mounting system 114 of the present disclosure has a simple design and may be easily incorporated into current cab designs. In fact, the present disclosure mounting system 114 provides facility for controlling, minimizing and preventing fore/aft movements of the cab 112 during machine operation. This restriction or limiting of movement of the cab 112 during operation of the machine 100 is especially beneficial as the machine 100 traverses irregular terrains by minimizing fore/aft movement which may otherwise affect the ride experience of the operator and the operator's perception from the cab 112.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cab frame mounting system comprising:
a cab mount to mount to a cab;
a frame mount to mount to a frame; and
a pin to couple the cab mount and the frame mount, defining a pin axis,
wherein the cab mount includes:
a bracket to be extended from the cab, the bracket having an upright member having an opening formed therein to receive the pin,
wherein the frame mount includes:
a mounting head including:
a base structure; and
a protruding head member extending from the base structure, the protruding head member including an opening formed therein to receive the pin;
an abutment portion to attach to the frame; and
an isolation member disposed between the base structure and the abutment portion, and
wherein the bracket includes:
a flange portion extending from the upright member along the same direction as the base structure, the bracket being coupled to the base structure of the mounting head with removable mechanical fasteners extending in a direction obliquely to the pin axis.

2. A cab frame mounting system comprising:
a cab mount to mount to a cab;
a frame mount to mount to a frame; and
a pin to couple the cab mount and the frame mount, defining a pin axis extending in a lateral direction,
wherein the cab mount includes:
a bracket to be extended from the cab, the bracket having an upright member having an opening formed therein to receive the pin,
wherein the frame mount includes:
a mounting head including:
a base structure; and
a protruding head member extending from the base structure, the protruding head member including an opening formed therein to receive the pin;
an abutment portion to attach to the frame; and
an isolation member disposed between the base structure and the abutment portion, and
wherein the bracket includes:
a flange portion extending from the upright member along the same direction as the base structure, the bracket being coupled to the base structure of the mounting head with removable mechanical fasteners extending in a downward direction away from the pin axis.
